(19) United States
(12) Patent Application Publication
(10) Pub. No.: US 2013/0223271 A1
(43) Pub. Date: Aug. 29, 2013

(54) METHOD AND APPARATUS FOR SIGNALLING MEASUREMENT SIGNALLING

(71) Applicants: Haiyang Huang, PuDong Jinqiao Shanghai (CN); Matthew Baker, Canterbury (GB); Teck Hu, Melbourne, FL (US); Qi Jiang, PuDong Jinqiao Shanghai (CN); Gang Shen, PuDong Jinqiao Shanghai (CN); Sudeep Palat, Greenwich (GB); Chandrika Worrall, Greenwich (GB)

(72) Inventors: Haiyang Huang, PuDong Jinqiao Shanghai (CN); Matthew Baker, Canterbury (GB); Teck Hu, Melbourne, FL (US); Qi Jiang, PuDong Jinqiao Shanghai (CN); Gang Shen, PuDong Jinqiao Shanghai (CN); Sudeep Palat, Greenwich (GB); Chandrika Worrall, Greenwich (GB)

(73) Assignee: ALCATEL LUCENT, Paris (FR)

(21) Appl. No.: 13/884,360

(22) PCT Filed: Nov. 10, 2010
(86) PCT No.: PCT/CN10/78592

§ 371 Date: May 9, 2013

(51) Int. Cl. H04W 72/02

(52) U.S. Cl. CPC H04W 72/02
USPC 370/252

(57) ABSTRACT

The eNB of a first cell being interfered by at least one second cell, obtains pattern information, from the eNB of the second cell or network configuration, indicating almost blank subframes that are configured by the eNB of the second cell or the network configuration; determines measurement signalling indicating subframes; and sends the measurement signalling to the UE. The UE in the first cell receives the measurement signalling from the serving eNB, the measurement signalling comprising at least one pattern information recommended by at least one second cell or network configuration, each of the pattern information indicating at least one almost blank subframe that is configured by the corresponding second cell; determines the resource used for measurement according to the measurement signalling; and carries out measurement on the determined resource.

### FIELD OF THE INVENTION

The invention relates to heterogeneous networks, particularly relates to eNBs and UEs in heterogeneous networks.

### BACKGROUND OF THE INVENTION

Heterogeneous networks (HetNets for abbreviation) have been added to the scope of the LTE-Advanced (LTE-A for abbreviation) work item and now enhanced inter-cell interference coordination (ICIC for abbreviation) for co-channel HetNet deployment is one of the key techniques for LTE Release 10 (Rel-10 for abbreviation).

Co-channel HetNets comprise macrocells and small cells operating on the same frequency channel. Such deployments present some specific interference scenarios for which new ICIC techniques are required.

In one scenario, the small cells are picocells, which are open to users of the macrocell network. In order to ensure that such picocells carry a useful share of the total traffic load, user equipment (UE) may be programmed to associate preferentially with the picocells rather than the macrocells, for example by biasing the SINR threshold at which they will select a picocell to associate with. Under such conditions, UEs near the edge of a picocell's coverage area will suffer strong interference from one or more macrocells. In order to alleviate such interference, some subframes may be configured as “blank” or “almost blank” in a macrocell. A blank subframe contains no transmission from the macrocell, while an “almost blank” subframe typically contains no data transmission and little or no control signalling transmission, but will contain reference signal transmissions in order to ensure backward compatibility with legacy terminals which expect to find the reference signals for measurements but are unaware of the configuration of almost blank subframes. Almost blank subframes may also contain synchronization signals, broadcast control information and/or paging signals.

In order to make the use of blank or almost blank subframes (ABSs for abbreviation) effective, note that hereafter the term “ABS” is used, and should be understood to include both blank and almost blank subframes, signalling is needed from the macrocell to the picocell across the corresponding backhaul interface, known in LTE as the “X2” interface. For LTE Rel-10, it has been agreed that this X2 signalling will take the form of a coordination bitmap to indicate the ABS pattern, for example with each bit corresponding to one subframe in a series of subframes, with the value of the bit indicating whether the subframe is an ABS or not. Such signalling can help the picocell to schedule data transmissions in the picocell appropriately to avoid interference, for example, by scheduling transmissions to UEs near the edge of the picocell during ABSs, and to signal to the UEs the subframes which should have low macrocell interference and should therefore be used for RRM and/or RLM and/or CSI measurement, here, RRM is the abbreviation for Radio Resource Management, typically relating to handover; RLM is the abbreviation for Radio Link Monitoring, typically relating to detection of serving radio link failure; CSI is the abbreviation for Channel State Information, typically relating to link adaptation on the serving radio link.

RRC signalling is then needed to indicate to the UEs the set of subframes which they should use for measurements, for example, for RLM and/or RRM and/or CSI.

Another scenario arises with HetNets in which the small cells are femtocells, which operate on a Closed Subscriber Group (CSG for abbreviation) basis, and are therefore typically not open to users of the macrocell network. In this case, the femtocells can cause strong interference to the macrocell UEs when these macrocell UEs come close to the femto eNBs. It may then be beneficial for the macrocells to indicate to their UEs the subframes in which they should make resource specific measurement, that is to say. The subframes in which interference from one or more femtocells is reduced or absent.

### SUMMARY OF THE INVENTION

Therefore, it is necessary to design a method and corresponding apparatus for signalling measurement signalling. The eNB of a first cell being interfered by at least one second cell, obtains pattern information, from the eNB of the second cell or network configuration, indicating almost blank subframes that are configured by the eNB of the second cell or the network configuration; determines measurement signalling indicating subframes; and sends the measurement signalling to the UE. The UE in the first cell receives the measurement signalling from the serving eNB, the measurement signalling comprising at least one pattern information recommended by at least one second cell or network configuration, each of the pattern information indicating at least one almost blank subframe that is configured by the corresponding second cell; determines the resource used for measurement according to the measurement signalling; and carries out measurement on the determined resource.

According to a first aspect of the present invention, there is provided a method, in an eNB of a first cell, of signalling measurement signalling to a UE of the first cell, the first cell being interfered by at least one second cell, comprising:

A. obtaining pattern information, from the eNB of the second cell or network configuration, indicating almost blank subframes that are configured by the eNB of the second cell or the network configuration;

B. determining measurement signalling indicating subframes;

C. sending the measurement signalling to the UE.

According to a second aspect of the present invention, there is provided a method in a UE in a first cell, of processing measurement signalling received from a serving eNB of the first cell, comprising:

a. receiving the measurement signalling from the serving eNB, the measurement signalling comprising at least one pattern information from at least one second cell, each of the pattern information indicating at least one almost blank subframe that is configured by the corresponding second cell;

b. determining the resource used for measurement according to the measurement signalling;

c. carrying out measurement on the determined resource.

According to a third aspect of the present invention, there is provided a first apparatus, in an eNB of a first cell, of signalling measurement signalling to a UE of the first cell, the first cell being interfered by at least one second cell, comprising:

an obtaining means configured to obtain pattern information, from the eNB of the second cell or network configuration, indicating the almost blank subframes that are configured by the eNB of the second cell or network configuration;

a first determining means configured to determine measurement signalling indicating subframes;

a sender configured to send the measurement signalling to the UE.

According to a fourth aspect of the present invention, there is provided a second apparatus in a UE in a first cell, of processing measurement signalling received from a serving eNB of the first cell, comprising:

a receiver configured to receive the measurement signalling from the serving eNB, the measurement signalling comprising at least one pattern information from at least one second cell, each of the pattern information indicating at least one almost blank subframe that is configured by the corresponding second cell;

a second determining means configured to determine the resource used for measurement according to the measurement signalling;

a measuring means configured to carrying out measurement on the determined resource.

With the embodiments of the present invention, the measurement signalling can be used as the reference to choose restricted resource for UE measurement, especially for RRM/RLM/CSI measurement which is important for the utilization for different scenarios.

### DESCRIPTION OF DRAWINGS

Other features, aspects and advantages of the present invention will become obvious by reading the following description of non-limiting embodiments with reference to the appended drawings.

FIG. 1 illustrates a schematic view of a HetNet according to one embodiment of the invention;

FIG. 2 illustrates a flowchart of a systematic method of signalling RRC measurement signalling according to one embodiment of the invention;

FIG. 3 to FIG. 6 illustrate respectively RRC IE according to embodiments of the present invention;

FIG. 7 illustrate a scenario of the ABS of macrocells 31, 32 and 33;

FIG. 8 to FIG. 10 illustrate respectively RRC IE according to embodiments of the present invention;

FIG. 11 illustrates a block diagram of an apparatus for signalling RRC measurement signalling according to one embodiment of the invention.

Wherein, same or similar reference numerals refer to the same or similar steps or means.

### DETAILED EMBODIMENTS OF THE INVENTION

The illustrative description of the embodiments of the present invention will be given in details combined with the appended figures.

For the ease of understanding, some technical terms are explained first:

A picocell is a wireless communication system typically covering a small area, such as in-building (offices, shopping malls, train stations, etc.), or more recently in-aircraft.

A femtocell is a small cellular base station, typically designed for use in a home or small business.

A macrocell is a cell in a mobile phone network that provides radio coverage served by a power cellular base station (tower). Generally, macrocells provide coverage larger than picocell and femtocell. The antennas for macrocells are mounted on ground-based masts, rooftops and other existing structures, at a height that provides a clear view over the surrounding buildings and terrain. Macrocell base stations have power outputs of typically tens of watts.

Heterogeneous networks are wireless networks using different access technologies. For example, a wireless network which provides a service through a wireless LAN and is able to maintain the service when switching to a cellular network is called a wireless heterogeneous network.

The embodiments of the invention propose design of the signalling to inform Rel-10 UEs of the subframes in which they should run certain resource-specific operation, such as RRM and/or RLM and/or CSI measurement.

In one scenario, a macro-pico scenario is described, wherein the first cell may be a picocell and the second cell may be a macrocell, and UEs near the edge of a picocell's coverage area suffer strong interference from one or more macrocells.

In another scenario, a macro-femto scenario is described, wherein the first cell may be a macrocell and the second cell may be a femtocell, and the femtocells operating on a CSG basis can cause strong interference to the macrocell UEs when these macrocell UEs come close to the femto eNBs as explained above.

Hereafter, for illustrative purposes only, the technical solution of the invention will be described mainly using a picocell 1 as an illustrative example of the first cell and macrocells 2 and 3 as an illustrative example of the second cell. It shall be appreciated that a person of ordinary skill in the art can then fully appreciate the implementation of the technical solution in relation to a macrocell as the first cell and a femtocell as the second cell, that is to say, the embodiments of the invention is equally applicable in scenarios where the macro UE suffers severe interference from the femto eNB.

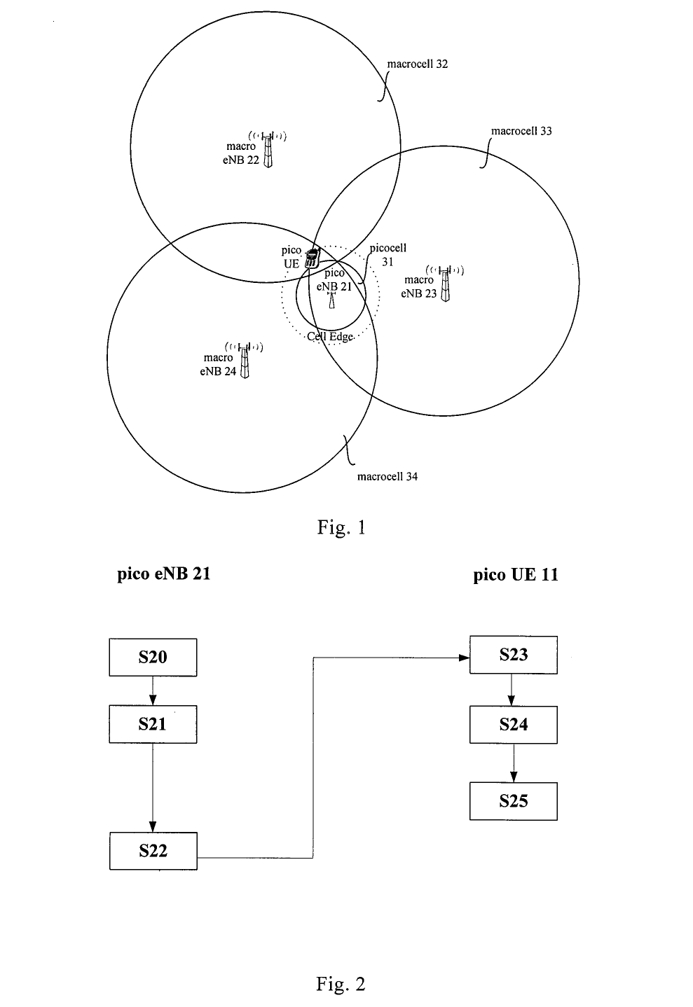

In addition, different macro eNBs may employ different ABS patterns. One pico UE may suffer interference from multiple macro eNBs, as depicted in FIG. 1. As a result, more than one ABS patterns can be received at the pico eNB from these multiple eNBs.

FIG. 1 illustrates a schematic view of a HetNet according to one embodiment of the invention. The UE 11 dominated by the eNB 21 in the picocell 31 suffers severe interference from the macrocell 32 and macrocell 33. Therefore, UE 11 is also called the interfered UE, and eNBs 22, 23 and 24 are also called aggressor eNBs.

FIG. 2 illustrates a flowchart of a systematic method of signalling measurement signalling according to one embodiment of the invention. Hereafter the method of signalling measurement signalling will be described by referring to FIG. 2 and in conjunction with FIG. 1.

Firstly, in step S20, the eNB 21 of the picocell 31 obtaining pattern information from the eNB 22 of the macrocell 32, pattern information from the eNB 23 of the macrocell 33 and the pattern information from the eNB 24 of the macrocell 34 or network configuration, indicating the almost blank subframes that are configured by the eNB 22 of the macrocell 32 and the eNB 23 of the macrocell 33 or network configuration.

In macro-pico scenario, the eNB 21 obtains pattern information from the eNB 22 and eNB 23, for example via X2 interface, and the pattern information indicates the almost blank subframes that are configured by the eNB of the second cell.

The pattern information, for example, is bitmaps received at the picocell 31 eNB 21. The bitmaps indicate the ABS pattern, for example with each bit corresponding to one subframe in a series of subframes, with the value of the bit indicating whether the subframe is an ABS or not. In an implementation where 2 bitmaps are sent over the X2, the following may apply:

First Bitmap: Semi-dynamic patterns that the aggressor eNB 22 and eNB 23 can utilize for co-channel interference avoidance scheduling, and may also be used by the picocell 31 UE 11 for some measurement purposes, for example CSI measurements.

Second Bitmap: It is a subset of the First Bitmap and is sent over X2 in semi-static manner. This Second Bitmap is expected to be signaled at least for the purpose of RLM measurement at the picocell 31 UE 11, and possibly also for some other measurement such as RRM/CSI measurement.

Of course, the pattern information received by the eNB 21 can also take other forms besides the First Bitmap and the Second Bitmap as illustrated above.

Alternatively, in the macro-femto scenario where the X2 interface between eNBs is omitted, the eNB 21 can also obtain the pattern information from the network configuration, and the pattern information indicates the almost blank subframes that are configured by the network configuration.

Then, in step S21, the eNB 21 determines measurement signalling indicating subframes.

The subframes that can be used by the UE 11, which are indicated in the measurement signalling, are preferred to be resource-restricted. That is to say, the resources that are indicated in the pattern information as almost blank are recommended in the measurement signalling to be used by the UE 11.

Then, in step S22, the eNB 21 sends the measurement signalling to the UE 11.

In an embodiment of the invention, the step S21 may further comprises that the eNB 21 determines UE-specific measurement signalling indicating the subframes that are used by specific UEs of the picocell 31 and/or cell-specific measurement signalling indicating the subframes that are used by all UEs of the picocell 31, and then the step S22 further comprises that the eNB 21 sends the UE-specific measurement signalling and/or broadcasts cell-specific measurement signalling to the UE.

In another embodiment of the invention, the pattern information comprises a first type information sent in a semi-dynamic manner and a second type information sent in a semi-static manner, and the step S21 further comprises that the eNB 21 determines the UE-specific measurement signalling from the first type information and determines the cell-specific measurement signalling from the second type information, and the step S22 further comprises that the eNB 21 sends the UE-specific measurement signalling and/or broadcasts cell-specific measurement signalling to the UE. UE-specific measurement signalling means that the eNB determines the measurement signalling for specific UEs and sends the determined measurement signalling to specific UEs, while cell-specific measurement signalling means that the eNB determines the measurement signalling for all the UEs in the picocell 31 and broadcasts the determined measurement signalling to all the UEs in the picocell 31.

To be specific, the first type information may be the First Bitmap described above and the second type information may be the Second Bitmap described above. The subframes that can be used by the UE of the picocell 31, which is indicated in the UE-specific signalling, might typically be from or a subset of the First Bitmap as described above. While the subframes that can be used by the UE of the picocell 31, which is indicated in the cell-specific signalling, might typically be from or a subset of the Second Bitmap as described above.

Of course, the relationship between the resource pattern indicated by the measurement signalling corresponding to a given macrocell and the X2-signalled ABS pattern indicated by the given macrocell to the picocell may also be unspecified and determined in a proprietary manner.

Both RLM/RRM and CSI measurement needs as much as possible available resource in a given time slot considering the requirements of preventing Radio Link Failure, scheduling, adaptive modulation and coding, etc. Moreover, only UEs which are interfered by the macro eNB need to be restricted in their CSI/RLM/RRM measurement.

By performing UE specific RRC to inform only specific UE(s), it addresses the scenario where not all the pico UEs would be suffering from severe interference from the macro eNB, i.e., pico UEs at cell edge would be experiencing higher interference than pico UEs at cell center. For these UEs where interference from macro eNB is not significant, no restrictions for CSI/RLM/RRM measurement are needed.

Besides, UE-specific signalling might be used to signal patterns that need to be updated often while cell-specific signalling might be used to signal patterns that are not updated often. Generally speaking, in order to obtain accurate channel information, CSI measurement needs to be reported quite often, and when handover occurs, the RRM measurement needs to be fed back to eNB frequently, while the RLM measurement can be reported with a reduced frequency. However, this does not preclude the use of UE-specific RRC signalling also for signalling patterns that are not updated often, if such patterns are applicable to only a subset of UEs in the cell.

Therefore, the UE-specific measurement signalling and the cell-specific measurement signalling are configured as one of the followings:
the UE-specific measurement signalling being used for CSI measurement and the cell-specific measurement signalling being used for RRM and RLM measurement;
the UE-specific measurement signalling being used for CSI, RRM and RLM measurement;
the cell-specific measurement signalling being used for CSI, RRM and RLM measurement;
the UE-specific measurement signalling being used for CSI and RRM measurement and the cell-specific measurement signalling being used for RLM measurement;
the UE-specific measurement signalling being used for RRM and RLM measurement and the cell-specific measurement signalling being used for CSI measurement.

In an variant embodiment of the present invention, when a plurality of ABS patterns for measurement are sent to the pico UE, the measurement signalling further comprises cell ID of each of the macrocell corresponding to each of the ABS pattern.

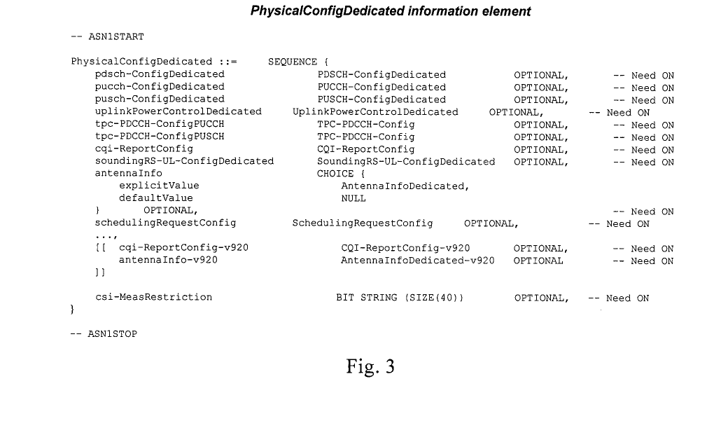

FIG. 3 to FIG. 7 illustrate respectively design for the measurement signalling. The design for the RRC signalling related to the CSI measurement is first given. Based on the R1-105779 in RAN1 #62bis, the resource used for CSI measurement should be the same or the subset of the first X2 bitmap with almost blank subframe (ABS) pattern for enhanced ICIC (eICIC) from macro eNB to pico eNB. Both UE-specific and cell-specific RRC signalling for CSI measurement can be available.

FIG. 3 illustrates the UE-Specific RRC signalling for CSI measurement. A new IE to carry this information for CSI measurement is given in FIG. 3, as “csi-MeasRestriction BIT STRING (SIZE(40)) OPTIONAL,—Need ON”.

This information is an UE-specific one in IE PhysicalConfigDedicated which carried by PDSCH in physical layer. Different UEs may share the different indications for CSI measurement depending on their positions or signal-to-interference-plus-noise ratio (SINR) status under the coverage of pico eNB. In order to keep the flexibility and match the recommended 40 ms X2 bitmap for eICIC from macro eNB, this new IE is also designed to be 40-bit length, where “1” in the bit string means the subframe for CSI measurement. Here we need to emphasize that, the position to carry CSI measurement may be different from the position to be blanked for macro eNB. The detailed modification for TS36.331 for this is listed below.

To be specific, PhysicalConfigDedicated field descriptions is given in the following Table 1:

TABLE 1
PhysicalConfigDedicated field descriptions

antennaInfo
A choice is used to indicate whether the antennaInfo is signalled explicitly
or set to the default antenna configuration as specified in section 9.2.4.
tpc-PDCCH-ConfigPUCCH
PDCCH configuration for power control of PUCCH using format 3/3A,
see TS 36.212 [22].
tpc-PDCCH-ConfigPUSCH
PDCCH configuration for power control of PUSCH using format 3/3A,
see TS 36.212 [22].
csi-MeasRestriction
40-bit to indicate which subframes are used for the CSI measurement
“0” denotes that the corresponding subframe not to be used for CSI
measurement
“1” denotes that the corresponding subframe to be used for CSI
measurement

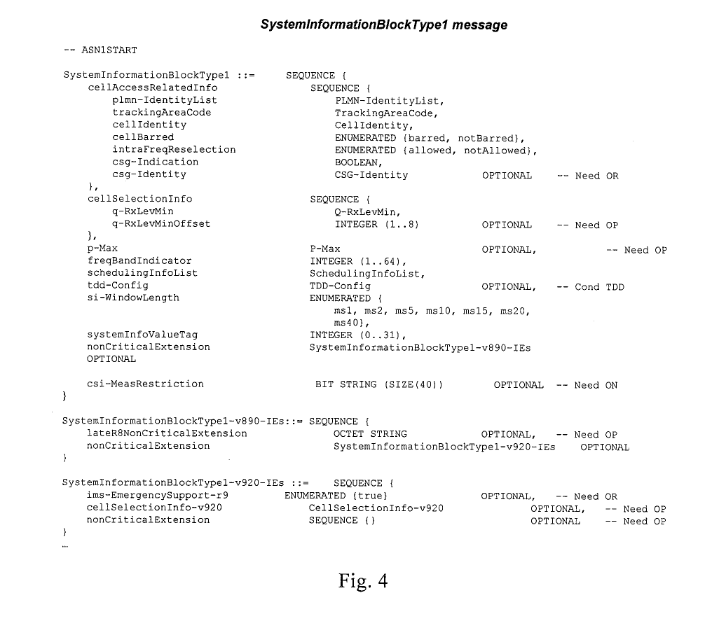

FIG. 4 illustrates the cell-specific RRC signalling for CSI measurement. A new IE to carry this information for CSI measurement is given in FIG. 4, as “csi-MeasRestriction BIT STRING (SIZE(40)) OPTIONAL,—Need ON”.

For cell-specific RRC signalling, the new IE “csi-MeasRestriction” can be carried in SystemInformationBlockType1 (SIB1) as the system information and broadcasted to all the UEs. The size of the bit string is still 40-bit. Here “1” denotes that the corresponding subframe to the ABS, and “0” denotes that the corresponding subframe to the normal or unrestricted subframe. This RRC signalling can be used as a CSI measurement reference for Rel-10 pico UEs.

To be specific, SystemInformationBlockType1 field descriptions is as the following Table 2:

TABLE 2
SystemInformationBlockType1 field descriptions

plmn-IdentityList
List of PLMN identities. The first listed PLMN-Identity is the primary
PLMN.
. . .
csi-MeasRestriction
“0” denotes that the corresponding subframe to the normal subframe
“1” denotes that the corresponding subframe to the almost blank subframe

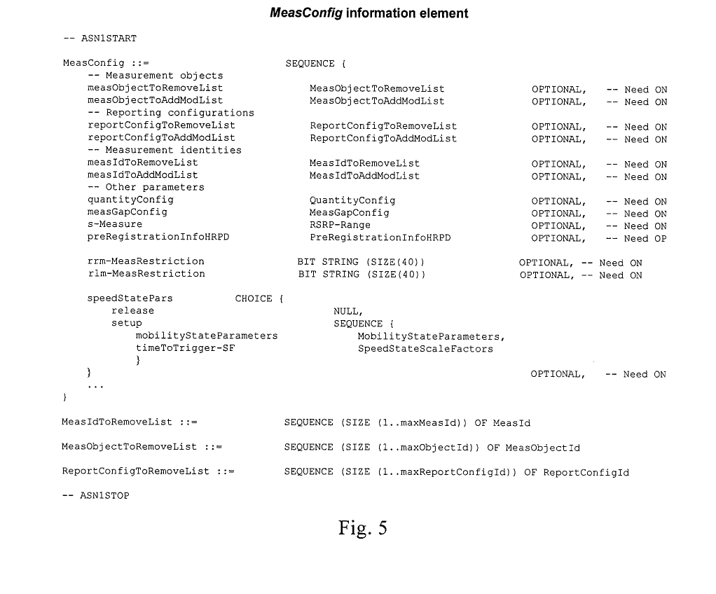

FIG. 5 illustrates the UE-specific RRC signalling for RRM/RLM measurement. Two new IEs to carry this information for RRM/RLM measurement are given in FIG. 5, as “rrm-MeasRestriction BIT STRING (SIZE(40)) OPTIONAL,—Need ON; and rlm-MeasRestriction BIT STRING (SIZE(40)) OPTIONAL,—Need ON”

In accordance with the description in the basic idea, some Rel-10 UEs need a specific pattern for its own, which may be different from others. Also from the performance point of view, this is the optimal solution. In this case, the aggressor eNB should provide UE-specific RRC signalling for pattern notification to the different UEs. As an example, the corresponding new information is added in following IE. For flexibility, we differentiate the pattern indication from RRM measurement to RLM measurement.

To be specific, MeasConfig information element is given as the following Table 3:

TABLE 3
MeasConfig information element

measObjectToRemoveList
List of measurement objects to remove.
. . .
rrm-MeasRestriction
40-bit to indicate which subframes are be used for the RRM measurement
“0” denotes that the corresponding subframe not to be used for RRM
measurement
“1” denotes that the corresponding subframe to be used for RRM
measurement
rlm-MeasRestriction
40-bit to indicate which subframes are be used for the RLM measurement
“0” denotes that the corresponding subframe not to be used for RLM
measurement
“1” denotes that the corresponding subframe to be used for RLM
measurement

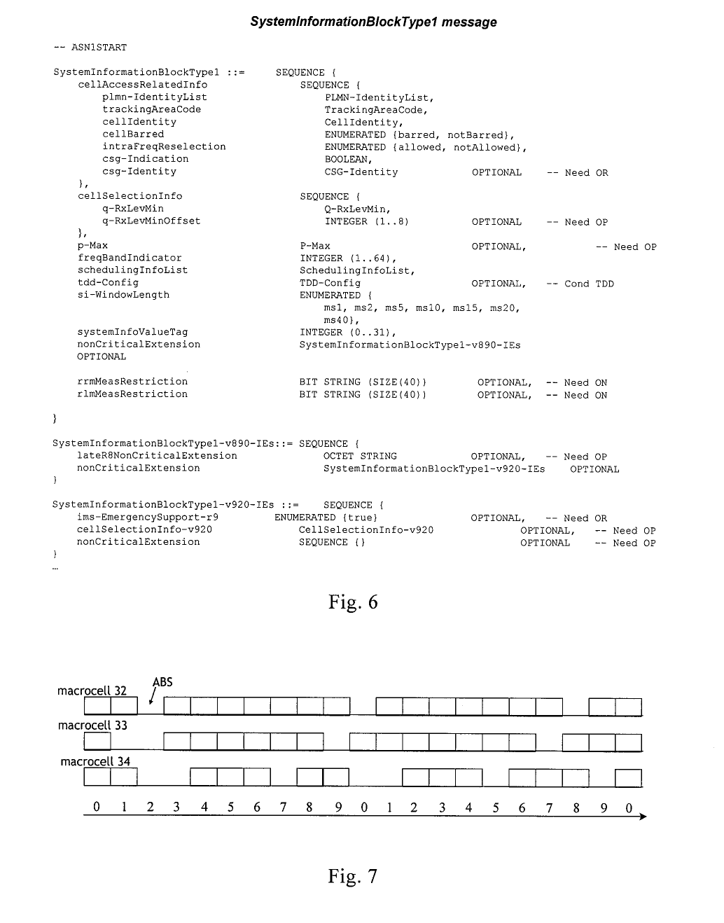

FIG. 6 illustrates the cell-specific RRC signalling for RRM/RLM Measurement. Two new IEs to carry this information for RRM/RLM measurement are given in FIG. 5, as “rrm-MeasRestriction BIT STRING (SIZE(40)) OPTIONAL,—Need ON; and rlm-MeasRestriction BIT STRING (SIZE(40)) OPTIONAL,—Need ON”

Since in an embodiment, RRM/RLM measurement for all the Rel-10 pico UEs may be performed in a semi-static mode without frequent change, a cell-specific signalling inserted in SystemInformationBlockType1 (SIB1) message may be a proper way.

One straightforward way to define it is based on the second X2 40 ms bitmap (it is for RRM/RLM measurement pattern coordination) from macro eNB.

For detailed information, the SystemInformationBlockType1 field descriptions is given as the following Table 4:

TABLE 4
SystemInformationBlockType1 field descriptions

plmn-IdentityList
List of PLMN identities. The first listed PLMN-Identity is the primary
PLMN.
. . .
rrmMeasRestriction
“0” denotes that the corresponding subframe not to be used for RRM
measurement
“1” denotes that the corresponding subframe to be used for RRM
measurement
rlmMeasRestriction
“0” denotes that the corresponding subframe not to be used for RLM
measurement
“1” denotes that the corresponding subframe to be used for RLM
measurement

The above descriptions mainly focus on how the picocell 31 eNB 21 sends measurement signalling to the UE, for example via RRC signalling. The following description will focus on how the UE behaves when it receives multiple RRC signalling for measurement.

Since from the above discussion, those skilled in the art can understand that the X2 signalling from the neighboring macro eNB is transmitted to pico eNB as the recommendation of the RRM/RLM/CSI measurement. However, since multiple macro eNB may have multiple X2 bitmap, for example, as depicted in FIG. 1, macro eNB 22, 23 and 24 may have their respective ABS patterns, and it is possible for pico UE to receive multiple RRC signalling for measurement based on different X2 bitmap from macro eNB. There the embodiments of the invention are used to define the UE behavior for this case.

The embodiments of the invention are described here in terms of a macro-pico scenario, but it should be understood that it applies equally to a macro-femto scenario as explained above.

Throughout this invention, we have used the example as depicted in FIG. 1, where the pico UE 11 suffers severe interference. It should be noted that this invention is equally applicable in scenarios where the macro UE suffers severe interference from the femto eNB.

In addition, different macro eNBs may employ different ABS patterns. One pico UE may suffer interference from multiple macro eNBs, as depicted in FIG. 1. As a result, more than one ABS patterns can be received at the pico eNB from these multiple eNBs. The UE behavior with multiple RRC signalling is included in the embodiments of the invention.

Prior to this invention, it is assumed that the pico eNB signals, for example, by RRC signalling, to the pico UEs a single pattern of subframes for resource-specific measurements. However with multiple macro eNBs, the pico eNB 21 could receive more than one ABS patterns through X2. In such an event, the pico eNB 21 could signal, for example, by RRC signalling, to the pico UE, for example, pico UE 11 one pattern of subframes corresponding to each of the interfering macrocells, for example, eNBs 22, 23 and 24. This RRC signalling for RRM/RLM/CSI can be UE-specific or cell-specific. The embodiments of the invention comprise the pico UE determining the pattern of subframes to use for resource-specific measurements.

Different embodiments of the above are described below:

Referring back to FIG. 2, after the eNB 21 sends the measurement signalling to the UE 11 in step S22, in step S23, the UE 11 receives the measurement signalling from the serving eNB 21, and the measurement signalling comprises at least one pattern information from at least one aggressor macrocell, each of the pattern information indicating at least one almost blank subframe that is configured by the corresponding macrocell. For example, referring to FIG. 7, the UE 11 receives the measurement signalling from the serving eNB 21, and the measurement signalling comprises three pattern information from three aggressor macrocell, namely, eNB 22, 23 and 24, and each of the pattern information indicates a blank subframe that is configured by the corresponding macrocell.

Then, in step S24, the UE 11 determines the resource used for measurement according to the measurement signalling.

Then, in step S25, the UE 11 carries out measurement on the determined resource.

In an embodiment of the present invention, the step S24 further comprises the following sub steps:

Step S240 (not shown in FIG. 2 for simplicity), the UE 11 selects, from the at least one macrocell, at least one candidate cell of which the interference caused to the UE needs to be considered, according to a predetermined rule;

In step S241 (not shown in FIG. 2 for simplicity), if one candidate cell is selected, then the UE 11 determines that the almost blank subframes configured by the candidate cell can be used for measurement. For example, only macrocell 32 sends its ABS pattern information via X2 interface to the eNB 21, and the eNB 21 sends the measurement signalling indicating the almost blank subframe of the macrocell 32, then the UE 11 can use at least part of the almost blank subframes indicated in the measurement signalling. It can be understood that since only one almost blank pattern information is sent via RRC signalling, there is no need to send the cell ID together with the measurement signalling.

In step S241, if a plurality of candidate cells are selected, the UE 11 determines that the intersection of the almost blank subframes configured by the plurality of candidate cells are used for measurement. In this scenario, since the pattern information of a plurality of aggressor macrocell eNBs are received by the UE 11, the cell ID of each aggressor macrocell should be included in the measurement signalling.

The pico UE 11 determines the pattern of subframes to use for measurements by determining the identity of the macrocell causing the highest interference and selecting the corresponding subframe pattern. In a detailed embodiment, the predetermined rule comprises any one of the followings:

The predetermined rule may be selecting the second cell that causes the highest interference to the UE as the candidate cells, in other words, muting the second cell with the highest interference can obtain highest quality measurement, or least interference. For example, the pico UE 11 determines the pattern of subframes to use for measurements by selecting the one of the patterns signaled by the picocell eNB 21 that gives the highest quality measurement for the serving picocell 31 (or the least interference). Referring to FIG. 7, for example, the macrocell 32 causes the strongest interference to the picocell 31, and the interference caused by the macrocell 32 should be given the first priority, therefore, the almost blank subframes of the macrocell 32 can be selected for measurement, therefore, the UE 11 can select the 10^{th} subframe for measurement.

The predetermined rule may also be that the UE 11 selects a predetermined number of second cells with the highest interference to the UE as the candidate cells, and then the UE 11 chooses from the intersection of the almost blank subframes configured by the plurality of candidate cells for measurement. For example, the pico UE 11 selects a pattern of subframes common to a plurality of the signaled patterns, e.g., by taking the logical “AND” of the patterns corresponding to the strongest interfering macrocells, so as to achieve the highest quality measurement for the serving picocell, or the least interference. In FIG. 7, only 2 complete radio frames comprising 10 subframes are shown. Those skilled in the art can understand that the radio frames shown in the figure are only for illustrative purpose, and they can modify the radio frame structure according to the standard or protocol that is actually used. Referring to FIG. 7, for example, macrocell 32 and macrocell 34 cause the strongest interference to the pico UE 11, therefore, the interference from the macrocell 32 and macrocell 34 can not be neglected. Therefore, muting the data and/or signalling transmission of the two macrocell 32 and 34 on the same subframe can improve the UE performance most. Therefore, the common subframe, that is, the #2 subframe (SF) of the #0 radio frame (RF) and the #0 SF of the #1 RF can be used for the UE 11 to carry out measurement. And it is up to UE 11 to decide which one of the two subframes the #2 SF of the #0 RF and the #0 SF of the #1 RF to use for measurement. The pico UE 11 may choose the #2 SF of the #0 RF or the #0 SF of the #1 RF, or both of them.
selecting at least one second cell with the interference caused to the UE above a predetermined threshold as the candidate cells. To be specific, a threshold may be applied to determine which patterns should be included in the logical “AND” operation at the pico UE 11; for example, only subframe patterns corresponding to macrocells giving a level of interference above a predetermined threshold might be included in the logical “AND” operation.

The UE side selection of the proper ABS pattern for measurement is described above, however, those skilled in the art can understand that the UE side selection is equally applicable to the pico eNB, that is to say, when the eNB obtains a plurality of ABS patterns, it can determine the subframes that is recommended for the pico UE to use for measurement based on the above predetermined rules. However, as the difference of location of the pico UE and pico eNB, the interference suffered by the pico UE is probably different from that suffered by the pico eNB, and therefore, the ABS pattern for measurement determined by the pico eNB for the pico UE may not be very accurate.

In the embodiments of the invention, RRC signalling is described in an illustrative manner. The details of the RRC signaling can refer to 3GPP LTE/LTE-A standard. Those skilled in the art that the embodiments of the invention can also apply to the corresponding high layer signalling of other standards, for example, MAC Control messages, the details of which can refer to IEEE802.16m, since the procedures are similar, the detailed descriptions are omitted for simplicity.

Beside, although we give an example that the ABS pattern is used for measurement, those skilled in the art can also understand that the ABS pattern can be used also for other purposes, for example, the measurement signalling is used to indicate the subframes that are used for measurement and/or scheduling and/or power control and/or cooperative relay and/or CoMP, etc.

According to the explanation of previous contents, several related cell-specific and UE-specific signalling to inform the X2 bitmap for measurement are deliberately designed.

Firstly the design for the RRC signalling related to the RRM/RLM/CSI measurement is provided. Based on the R1-105779 in RAN1 #62bis, the resource used for CSI measurement should be the same or the subset of the first X2 bitmap with almost blank subframe (ABS) pattern for enhanced ICIC (eICIC) from macro eNB to pico eNB. Both UE-specific and cell-specific RRC signalling for CSI measurement can be available.

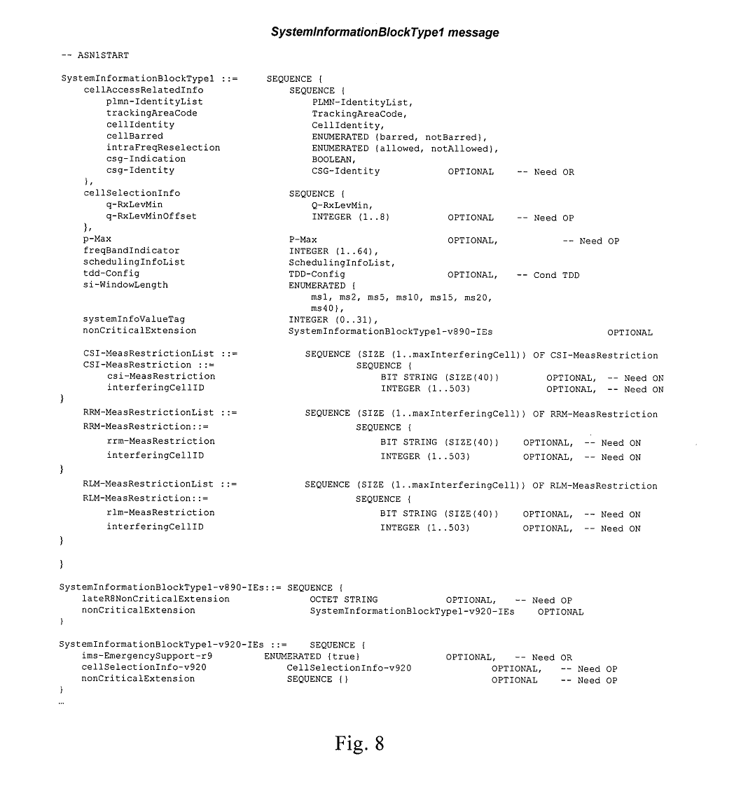

FIG. 8 illustrates cell-Specific RRC signalling for RRM/RLM/CSI measurement. For cell-specific RRC signalling, the new IE “rrm/rlm-MeasRestriction” and “csi-MeasRestriction” can be carried in SystemInformationBlockType1 as the system information and broadcasted to all the UEs. To be specific, the

“

CSI-MeasRestrictionList ::= SEQUENCE (SIZE (1..maxInterferingCell)) OF CSI-MeasRestriction

| | |
|---|---|
| CSI-MeasRestriction ::= | SEQUENCE { |
| csi-MeasRestriction | BIT STRING (SIZE(40)) OPTIONAL, -- Need ON |
| interferingCellID | INTEGER (1..503) OPTIONAL, -- Need ON |
| }”, | |
| “ | |

RRM-MeasRestrictionList ::= SEQUENCE (SIZE (1..maxInterferingCell)) OF RRM-MeasRestriction

| | | |
|---|---|---|
| RRM-MeasRestriction::= | SEQUENCE { | |
| rrm-MeasRestriction | BIT STRING (SIZE(40)) | OPTIONAL, -- Need ON |
| interferingCellID | INTEGER (1..503) | OPTIONAL, -- Need ON |
| }” and | | |
| “ | | |

RLM-MeasRestrictionList ::= SEQUENCE (SIZE (1..maxInterferingCell)) OF RLM-MeasRestriction

| | | |
|---|---|---|
| RLM-MeasRestriction::= | SEQUENCE { | |
| rlm-MeasRestriction | BIT STRING (SIZE(40)) | OPTIONAL, -- Need ON |
| interferingCellID | INTEGER (1..503) | OPTIONAL, -- Need ON |
| }” | | |

are new. The size of the bit string is still 40-bit. Here “1” denotes that the corresponding subframe to the ABS, and “0” denotes that the corresponding subframe to the normal subframe. This RRC signalling carry the information from multiple X2 bitmap from neighboring interfering cell and can be used as a measurement reference for different Rel-10 UEs based on their positions. Then the Rel-10 UE will perform its related behavior based on the above discussion. The SystemInformationBlockType1 field is described in the following Table 5:

TABLE 5
SystemInformationBlockType1 field descriptions

plmn-IdentityList
List of PLMN identities. The first listed PLMN-Identity is the primary
PLMN.
. . .
csi-MeasRestriction
40-bit to indicate the ABS pattern for eICIC carried by X2 from the
neighbour cell
“0” denotes that the corresponding subframe not to be configured as ABS
by neighbour cell
“1” denotes that the corresponding subframe to be configured as ABS by
neighbour cell
rrm-MeasRestriction
40-bit to indicate the ABS pattern for RRM measurement recommendation
carried by X2 from the neighbour cell
“0” denotes that the corresponding subframe not to be recommended for
RRM measurement by neighbour cell
“1” denotes that the corresponding subframe to be recommended for RRM
measurement by neighbour cell
rlm-MeasRestriction
40-bit to indicate the ABS pattern for RLM measurement recommendation
carried by X2 from the neighbour cell
“0” denotes that the corresponding subframe not to be recommended for
RLM measurement by neighbour cell
“1” denotes that the corresponding subframe to be recommended for RLM
measurement by neighbour cell
interferingCellID
It denotes the physical ID of the corresponding aggressor eNB
maxInterferingCell
It denotes the maximal number of involved aggressor eNBs

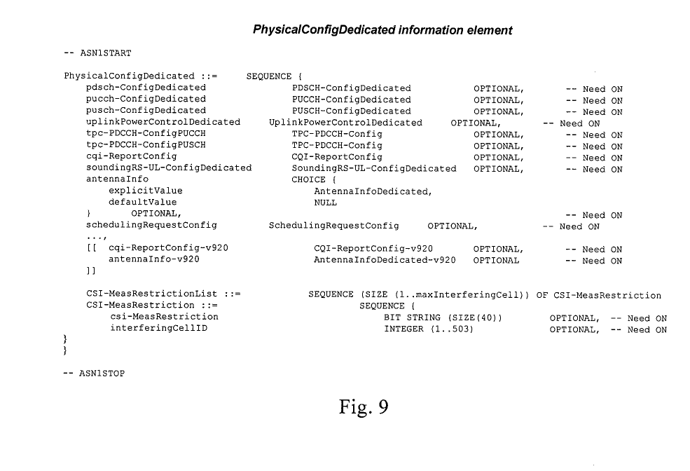

FIG. 9 illustrates UE-Specific RRC signalling for CSI measurement. For UE-specific RRC signalling, the new IE “csi-MeasRestriction” can be carried in PhysicalConfigDedicated field which carried by PDSCH in physical layer. To be specific, the

“
CSI-MeasRestrictionList ::= SEQUENCE (SIZE (1..maxInterferingCell)) OF CSI-MeasRestriction
CSI-MeasRestriction ::= SEQUENCE {

| | | | |
|---|---|---|---|
| csi-MeasRestriction | BIT STRING (SIZE(40)) | OPTIONAL, | -- Need ON |
| interferingCellID | INTEGER (1..503) | OPTIONAL, | -- Need ON |
| }” | | | |

is new.

To be specific, the PhysicalConfigDedicated field descriptions is given in the following Table 6:

TABLE 6
PhysicalConfigDedicated field descriptions

antennaInfo
A choice is used to indicate whether the antennaInfo is signalled explicitly
or set to the default antenna configuration as specified in section 9.2.4.
tpc-PDCCH-ConfigPUCCH
PDCCH configuration for power control of PUCCH using format 3/3A,
see TS 36.212 [22].
tpc-PDCCH-ConfigPUSCH
PDCCH configuration for power control of PUSCH using format 3/3A,
see TS 36.212 [22].
csi-MeasRestriction
40-bit to indicate the ABS pattern for eICIC carried by X2 from the
neighbour cell
“0” denotes that the corresponding subframe not to be configured as ABS
by neighbour cell
“1” denotes that the corresponding subframe to be configured as ABS by
neighbour cell

In accordance with the description in the basic idea, some Rel-10 UEs need a specific pattern for its own, which may be different from others. Also from the performance point of view, this is the optimal solution. In this case, the aggressor eNB should provide UE-specific RRC signalling for pattern notification to the different UEs. As an example, the corresponding new information is added in following IE. For flexibility, we differentiate the pattern indication from RRM measurement to RLM measurement.

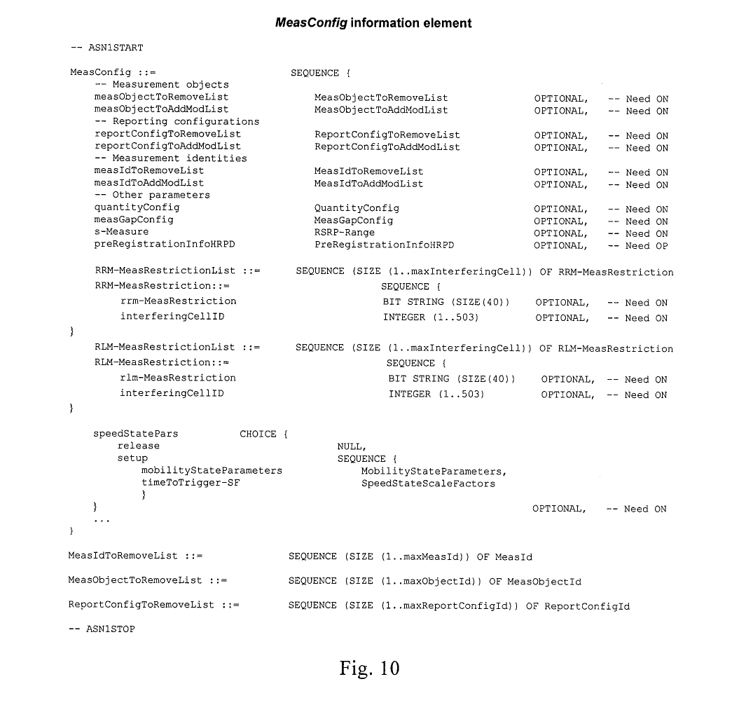

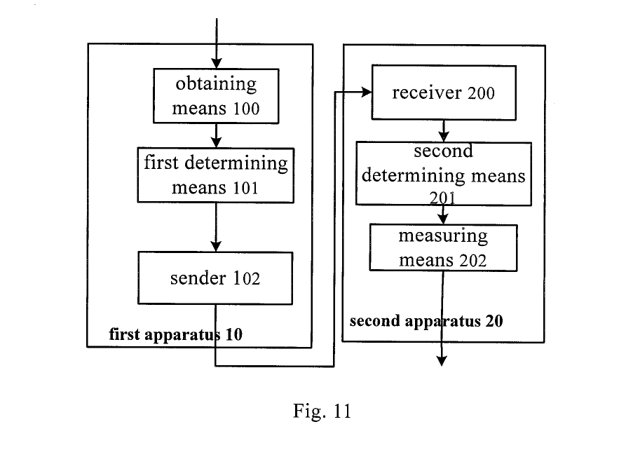

FIG. 10 illustrates UE-Specific RRC signalling for RRM/RLM measurement. For UE-specific RRC signalling, the new IE “rrm-MeasRestriction” and “rrm-MeasRestriction” can be carried in MeasConfig information element. To be specific, the

“

| RRM-MeasRestrictionList ::= | SEQUENCE (SIZE (1..maxInterferingCell)) OF | | |
|---|---|---|---|
| RRM-MeasRestriction | | | |
| RRM-MeasRestriction::= | SEQUENCE { | | |
| rrm-MeasRestriction | BIT STRING (SIZE(40)) | OPTIONAL, | -- Need ON |
| interferingCellID | INTEGER (1..503) | OPTIONAL, | -- Need ON |
| } | | | |
| RLM-MeasRestrictionList ::= | SEQUENCE (SIZE (1..maxInterferingCell)) OF | | |
| RLM-MeasRestriction | | | |
| RLM-MeasRestriction::= | SEQUENCE { | | |
| rlm-MeasRestriction | BIT STRING (SIZE(40)) | OPTIONAL, | -- Need ON |
| interferingCellID | INTEGER (1..503) | OPTIONAL, | -- Need ON |
| } | | | |
| ” are new. | | | |

To be specific, the MeasConfig information element descriptions is given in the following Table 7:

TABLE 7
MeasConfig information element

measObjectToRemoveList
List of measurement objects to remove.
. . .
rrm-MeasRestriction
40-bit to indicate which subframes are be used for the RRM measurement
“0” denotes that the corresponding subframe not to be used for RRM
measurement
“1” denotes that the corresponding subframe to be used for RRM
measurement
rlm-MeasRestriction
40-bit to indicate which subframes are be used for the RLM measurement
“0” denotes that the corresponding subframe not to be used for RLM
measurement
“1” denotes that the corresponding subframe to be used for RLM
measurement

The above description mainly focuses on the procedure of the embodiments of the invention, the followings will mainly focus on the block diagram of the invention.

A first apparatus 10 is in eNB 21 of picocell 31, of signalling measurement signalling to a UE 11 of the picocell 31, and the picocell 31 is interfered by at least one macrocell, the first apparatus 10 comprises:

an obtaining means 100 configured to obtain pattern information, from the eNB of the second cell or network configuration, indicating the almost blank subframes that are configured by the eNB of the second cell or network configuration;

a first determining means 101 configured to determine measurement signalling indicating subframes;

a sender 102 configured to send the measurement signalling to the UE.

A second apparatus 20 in a UE 11 in a picocell 31, of processing measurement signalling received from a serving eNB of the picocell 31, comprising:

a receiver 200 configured to receive the measurement signalling from the serving eNB, the measurement signalling comprising at least one pattern information from at least one second cell, each of the pattern information indicating at least one almost blank subframe that is configured by the corresponding second cell;

a second determining means 201 configured to determine the resource used for measurement according to the measurement signalling;

a measuring means 202 configured to carrying out measurement on the determined resource.

It should be noted that the above-mentioned embodiments illustrate rather than limit the invention and that those skilled in the art would be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the apparatus claims enumerating several units, several of these units can be embodied by one and the same item of hardware or software. The usage of the words first, second and third, et cetera, does not indicate any ordering. These words are to be interpreted as names.

1. A method, in an eNB of a first cell, of signalling measurement signalling to a UE of the first cell, the first cell being interfered by at least one second cell, comprising:
obtaining pattern information, from the eNB of the second cell or network configuration, indicating almost blank subframes that are configured by the eNB of the second cell or the network configuration;
determining measurement signalling indicating subframes;
sending the measurement signalling to the UE.

2. A method as claimed in claim 1, wherein the determining measurement signalling indicating subframes further comprises:
determining UE-specific measurement signalling indicating the subframes that are used by specific UEs of the first cell and/or cell-specific measurement signalling indicating the subframes that are used by all UEs of the first cell;
and the sending the measurement signalling to the UE further comprises:
sending the UE-specific measurement signalling and/or broadcasting cell-specific measurement signalling to the UE.

3. A method as claimed in claim 2, wherein the pattern information comprises a first type information sent in a semi-dynamic manner and a second type information sent in a semi-static manner, and the determining measurement signalling indicating subframes further comprises:
determining the UE-specific measurement signalling from the first type information and determining the cell-specific measurement signalling from the second type information;
the sending the measurement signalling to the UE further comprises:
sending the UE-specific measurement signalling and/or broadcasting cell-specific measurement signalling to the UE.

4. A method as claimed in claim 2, wherein the UE-specific measurement signalling and the cell-specific measurement signalling are configured as one of the following:
the UE-specific measurement signalling being used for CSI measurement and the cell-specific measurement signalling being used for RRM and RLM measurement;
the UE-specific measurement signalling being used for CSI, RRM and RLM measurement;
the cell-specific measurement signalling being used for CSI, RRM and RLM measurement;
the UE-specific measurement signalling being used for CSI and RRM measurement and the cell-specific measurement signalling being used for RLM measurement;
the UE-specific measurement signalling being used for RRM and RLM measurement and the cell-specific measurement signalling being used for CSI measurement.

5. A method as claimed in claim 1, wherein the measurement signalling further comprises cell ID of each of the at least one second cell.

6. A method as claimed in claim 1, wherein the measurement signalling is contained in RRC or MAC Control messages, and/or the measurement signalling is used to indicate the subframes that are used for measurement and/or scheduling and/or power control and/or cooperative relay and/or CoMP, and/or the first cell and the second cell are configured as one of the following:
the first cell being a picocell and the second cell being a macrocell;
the first cell being a macrocell and the second cell being a femtocell.

7. A method in a UE in a first cell, of processing measurement signalling received from a serving eNB of the first cell, comprising:
receiving the measurement signalling from the serving eNB, the measurement signalling comprising at least one pattern information from at least one second cell, each of the pattern information indicating at least one almost blank subframe that is configured by the corresponding second cell;
determining the resource used for measurement according to the measurement signalling;
carrying out measurement on the determined resource.

8. A method according to claim 7, wherein the measurement signalling received from the serving eNB further comprises at least one cell ID of at least one second cell.

9. A method according to claim 7, wherein the determining the resource used for measurement according to the measurement signalling further comprises:
selecting, from the at least one second cell, at least one candidate cell of which the interference caused to the UE needs to be considered, according to a predetermined rule;
if one candidate cell is selected, determining that the almost blank subframes configured by the candidate cell are used for measurement;
if a plurality of candidate cells are selected, determining that the intersection of the almost blank subframes configured by the plurality of candidate cells are used for measurement.

10. A method as claimed in claim 9, wherein, the predetermined rule comprises any one of the following:
selecting the second cell that causes the highest interference to the UE as the candidate cells;
selecting a predetermined number of second cells with the highest interference to the UE as the candidate cells;
selecting at least one second cell with the interference caused to the UE above a predetermined threshold as the candidate cells.

11. A method as claimed in claim 7, wherein the receiving the measurement signalling from the serving eNB further comprises:
receiving the UE-specific and cell-specific measurement signalling from the serving eNB;
the determining the resource used for measurement according to the measurement signalling further comprises:
overwriting the cell-specific measurement signalling with the UE-specific measurement signalling.

12. A method as claimed in claim 11, wherein the measurement signalling further comprises a trigger to indicate the moment for the UE to cease UE-specific measurement on the determined resource;
when the trigger is enabled, the method further comprises carrying out measurement on the determined resource:
perform unrestricted measurement or measurement on resource obtained according to the cell-specific measurement signalling

13. A method according to claim 7, wherein the first cell and the second cell are configured as one of the following:
the first cell being a picocell and the second cell being a macrocell;
the first cell being a macrocell and the second cell being a femtocell.

14. A first apparatus, in an eNB of a first cell, of signalling measurement signalling to a UE of the first cell, the first cell being interfered by at least one second cell, comprising:
an obtaining means configured to obtain pattern information, from the eNB of the second cell or network configuration, indicating the almost blank subframes that are configured by the eNB of the second cell or network configuration;
a first determining means configured to determine measurement signalling indicating subframes;
a sender configured to send the measurement signalling to the UE.

15. A second apparatus in a UE in a first cell, of processing measurement signalling received from a serving eNB of the first cell, comprising:
a receiver configured to receive the measurement signalling from the serving eNB, the measurement signalling comprising at least one pattern information from at least one second cell, each of the pattern information indicating at least one almost blank subframe that is configured by the corresponding second cell;
a second determining means configured to determine the resource used for measurement according to the measurement signalling;
a measuring means configured to carrying out measurement on the determined resource.
